(19) United States
(12) Patent Application Publication
(10) Pub. No.: US 2018/0229437 A1
(43) Pub. Date: Aug. 16, 2018

(54) WINDSHIELD BOND STRENGTH ASSESSMENT BY TERAHERTZ SPECTROSCOPY

(71) Applicant: FORD GLOBAL TECHNOLOGIES, LLC, Dearborn, MI (US)

(72) Inventors: Tony Misovski, Oxford, MI (US); Mark Edward Nichols, Saline, MI (US)

(73) Assignee: FORD GLOBAL TECHNOLOGIES, LLC, Dearborn, MI (US)

(21) Appl. No.: 15/434,576

(22) Filed: Feb. 16, 2017

(51) Int. Cl. B29C 65/48; B29C 65/14; B60J 1/00

(52) U.S. Cl. CPC B29C 65/48; B29L 2031/3052; B60J 1/006; B29C 65/1403

(57) ABSTRACT

A method of assessing cure rate of an adhesive adhering a windshield to a flange includes, by a controller, operating a terahertz beam generator to direct a terahertz beam at a windshield-flange interface, periodically measuring the light from the beam reflected from the adhesive, and outputting a cure rate of the adhesive based on a refractive index associated with the light from the beam reflected from the adhesive.

### TECHNICAL FIELD

The disclosure relates to an apparatus for assessing cure rate and/or cure state of an adhesive at a windshield-flange interface using terahertz spectroscopy and a related method.

### BACKGROUND

A proper bond of the windshield to the vehicle body flange may be important. The typical adhesives used in the windshield-flange interface require humidity to cure. In addition, humidity is required to provide proper surface activation at the interface. Yet, fluctuation of the relative humidity in the air in a plant and/or outdoors, where the windshield is installed and cured, may result in fluctuating cure rate values of the adhesive at the interface. As a result, it is difficult to evaluate the time required for a desirable adhesive cure.

### SUMMARY

In at least one embodiment, a method of assessing cure rate of an adhesive adhering a windshield to a flange is disclosed. The method includes, by a controller, operating a terahertz pulsed beam generator to direct a terahertz pulsed beam at a windshield-flange interface. The method further includes periodically measuring the light from the beam reflected from the adhesive. The method also includes outputting a cure rate of the adhesive based on a refractive index associated with the light from the beam reflected from the adhesive. The method may further include comparing the output to a threshold cure rate or a cure rate model of the adhesive. The measuring may include at least one measurement a day. The method may include adjusting an output cure rate to account for at least one other interface and a thickness of the windshield. The method may include outputting a predicted cure rate based on the cure rate and a relative humidity level or other atmospheric conditions. The cure rate may be expressed as a percentage of a threshold cure rate. The method may include outputting an estimate of time remaining to reach a threshold cure rate based on the output cure rate.

In another embodiment, an apparatus is disclosed. The apparatus may include a terahertz beam generator directed at a windshield-flange interface including an adhesive. The apparatus may further include a controller programmed to activate the terahertz beam generator to generate a terahertz beam, and generate output indicative of a cure rate of the adhesive based on a refractive index associated with light from the beam reflected from the adhesive. The output may be generated while the beam scans at least a portion of the interface. The output may be an estimate of time remaining to reach a threshold cure rate of the adhesive. The output may be a percentage of a threshold cure rate of the adhesive. The controller may be further programmed to compare the output to an input, the input being a threshold refractive index value, threshold cure rate, threshold speed of a refraction, or a cure rate model of the adhesive. The controller may be programmed to activate the beam generator to generate a terahertz beam periodically.

In a yet further embodiment, an alternative apparatus is disclosed. The apparatus may include a controller programmed to activate a beam generator to generate a terahertz beam directed at an adhesive of a glass-metal flange interface, and generate output indicating status of a cure rate of the adhesive based on a refractive index associated with velocity of light of the beam refracted from the adhesive and a threshold adhesive cure rate. The glass-metal flange interface may include a windshield-flange interface. The glass-metal flange interface may include a rear vehicular glass-flange interface. The output may be generated periodically. The controller may be further programmed to estimate time remaining to reach the threshold adhesive cure rate based on the output. The status may be a percentage of the threshold adhesive cure rate. The controller may be further programmed to generate output indicating status of a cure rate of the adhesive based on a refractive index associated with velocity of light of the beam refracted from the adhesive and a threshold adhesive cure rate.

### BRIEF DESCRIPTION OF THE DRAWINGS

FIG. 1 depicts a schematic perspective view of a portion of a vehicle body with a windshield-flange interface;

FIGS. 2A and 2B depict schematic cross-sectional views of the windshield-flange interface in a section taken along the lines 2A, 2B-2A, 2B;

FIG. 3 shows a schematic cross-sectional view of the windshield-flange interface of a vehicle body depicted in FIG. 4A in a section taken along the lines 3, 6A-3, 6A;

FIG. 4A depicts a perspective schematic view of a vehicle body with a windshield-flange interface and an instrument capable of measuring thickness of an adhesive layer at the interface and monitoring cure state of the adhesive;

FIG. 4B shows a perspective schematic view of a vehicle body with a rear window-flange interface and an instrument including a robot arm capable of measuring thickness of an adhesive layer at the interface and monitoring cure state of the adhesive;

FIG. 5 shows an example plot of a simulated terahertz waveform against the actual waveform regarding an automotive paint system;

FIG. 6A shows a schematic cross-sectional view of the windshield-flange interface of the vehicle body depicted in FIG. 4 in a section taken along the lines 3, 6A-3, 6A; and

FIG. 6B shows a schematic cross-sectional view of the rear window-flange interface of a vehicle body depicted in FIGS. 4A, 4B in a section taken along the lines 6B-6B.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except where expressly indicated, all numerical quantities in this description indicating dimensions or material properties are to be understood as modified by the word “about” in describing the broadest scope of the present disclosure.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property. Typically, the windshield and other windows are installed in a window frame using adhesives.

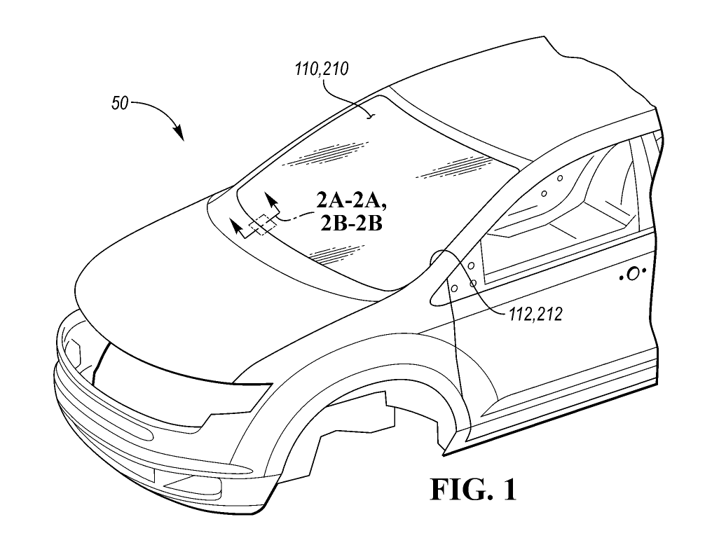

A windshield or a windscreen is the front window of a vehicle such as a car, bus, motorbike, tram, aircraft. Typical windshield is made from laminated safety glass including a number of curved sheets of glass with a plastic layer laminated between the glass. The remaining automotive windows are typically not laminated. Yet, side windows of some luxury cars may be laminated to improve sound deadening. An example vehicle windshield-flange interface 100, 200 on a vehicle body 50 is depicted in FIG. 1.

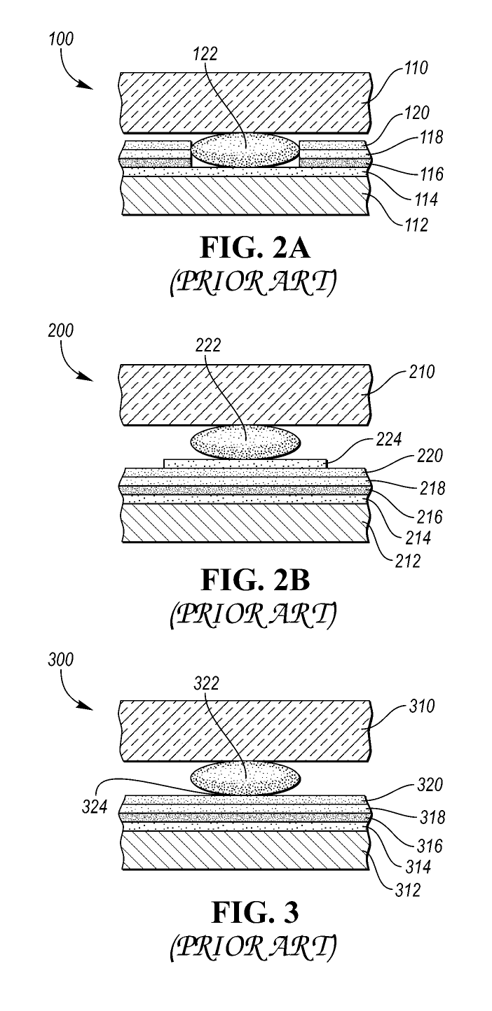

FIGS. 2A and 2B illustrate typical stratification of various layers applied between the windshield 110, 210 and the windshield flange 112, 212 which is a portion of the window frame (not depicted). The various layers of the windshield-flange interfaces 100, 200 fulfill different functions such as providing corrosion resistance, smoothing a previously applied coating, protecting a previously applied coating from UV light, promoting adhesion, the like, or a combination thereof. Therefore, the various layers typically include layers of varying thicknesses and chemical compositions. The layers may include an electro coat 114, 214 which forms a layer in an immediate contact with the windshield flange 112, 212. The typical layer system also includes a primer 116, 216 a basecoat 118, 218, and a clearcoat 120, 220.

Bonding of the windshield 110, 210 to the clear coat 120, 220 has proven to be a challenge, especially with an older generation of adhesives such as those used before the year 2000. The adhesives would not bond directly to the clearcoat surface 120, 220. Two different methods to overcome this problem have been identified. First, depicted in FIG. 2A, utilizes a mask (not depicted) after application of the electro coat 114 and prior to application of the paint layers 116, 118, and 120. The method keeps the primer 116, the basecoat 118, and the clearcoat 120 off the flange 112. The adhesive 122 bonds the windshield 110 to the electro coat 114.

Alternatively, as is illustrated in FIG. 2B, the electro coat 214 is applied onto the flange 212, followed by the primer 216, basecoat 218, and the clear coat 220. A windshield primer 224 is then applied directly onto the clearcoat 220 which would allow the adhesive 222 to bond the windshield 210 to the windshield primer 224.

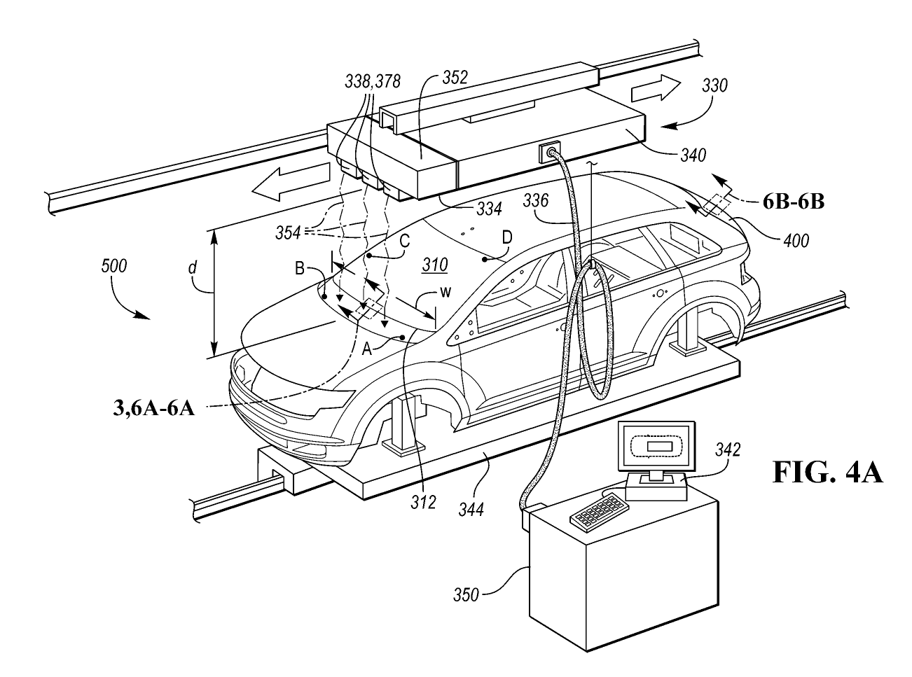

Both of the described methods are effective, yet they are also costly in labor and materials. Therefore, a new generation of clearcoats 314 has been developed. As is illustrated in FIG. 3, the windshield-flange interface 300 includes a plurality of layers between the windshield 310 and the flange 312. The layers include an electro coat 314 which is applied onto the flange 312, followed by a primer 316, a basecoat 318, and a clearcoat 320. The clearcoats' 320 chemistry allows direct application of the adhesive 322 to the clearcoat 320. While the chemistry of the individual clearcoats differs, most clearcoat-adhesive interfaces 324 require moisture or certain level of humidity for activation of the proper surface chemistry. In addition, the adhesive 322 requires moisture to cure.

Yet, the reliance on humidity to provide the proper surface activation and adhesive cure has presented a new set of challenges. This is especially true in geographical locations where the relative humidity falls below a desirable level of humidity which enables the proper surface action and cure of the adhesives. An example of the problematic regions includes areas where the relative humidity falls below 50%, 40%, 30%, or the like. The regions may include geographical areas which experience temperatures below freezing during winter months such as the Midwestern states of the United States. When the humidity is below the desirable threshold, proper surface activation is not achieved during a normal allotted time frame. The moisture-related clearcoat surface activation problem has thus been addressed, for example, by including additional functional groups in the clearcoat's chemistry. The functional groups reduce the amount of humidity required for the surface activation.

Yet, it remains to be a problem to identify whether the air is humid enough throughout the curing process to provide proper cure to the adhesive such that the windshield can fully adhere to the flange. In other words, it remains to be a problem to determine whether a sufficient adhesive cure has been achieved within an allotted time frame. Generally, the adhesive achieves the desired cure state within a span of about 7 to 10 days. Yet, under certain circumstances such as lower relative humidity, more time may be required for a proper cure. Proper windshield adhesion to the flange is an important part of occupant safety, and is governed by the Federal Motor Vehicle Safety Statutes (FMVSS). Thus, it is important that a windshield is properly bonded to the vehicle body before a customer takes delivery of the vehicle. Thus, it would be desirable to know when the proper cure occurs.

The typical test methods for identification of the adhesive cure on the windshield-flange interface include destructive methods requiring dismantling of the windshield-flange interface to assess the adhesive and determine its cure state. Such technique is costly and time-consuming. Additionally, the assessment methods usually check the adhesive cure in spots instead of around the entire periphery of the windshield-flange interface which results in a very limited amount of data.

A direct visual inspection of the applied adhesive is not possible because the applied adhesive is obscured by a black-out material on the windshield. A visual inspection may be done at a plant where an adhesive bead is applied to a recently clearcoated and baked panel. The panel sits open without glass for about a week. A knife test may be performed to assess the separation mode of the adhesive from the panel. Yet, this test does not typically provide accurate results because the bead has a larger surface area exposed to atmospheric moisture than the adhesive applied to the windshield-flange interface.

Thus, it is desirable to provide a method of assessing adhesive cure state without damaging or destroying the windshield-flange interface. Therefore, it would be desirable to provide a non-destructive and/or non-contacting method so that the interface remains intact. Additionally, it would be desirable to develop an assessing method which would be capable of providing spot as well as line and/or area scan data.

In one or more embodiments, a method of assessing cure rate of an adhesive adhering a windshield to a flange is disclosed. Besides a windshield, the method described herein is applicable to any piece of fixed non-moveable glazing. The method utilizes terahertz spectroscopy as a non-destructive test to measure the cure state of an adhesive to determine when adequate adhesion of the windshield to a flange has occurred. The method, as described below, may be used to assess a windshield-flange interface or a glass-metal interface of any type of vehicle. Non-limiting exemplary types of vehicles include land vehicles such automobiles, buses, vehicles for transportation of goods, motorcycles, off-road vehicles, tracked vehicles, amphibious vehicles, or the like.

Terahertz radiation, also known as submillimeter radiation, or THz, consists of electromagnetic waves within the International Telecommunications Union-designated band of frequencies from about 0.3 to about 3 terahertz. Wavelength of radiation in the terahertz band ranges from about 1 mm to about 100 μm. Terahertz radiation represents a region between microwaves and infrared light waves in the electromagnetic spectrum also known as the terahertz gap. Terahertz radiation is non-ionizing, travels in a line of sight, and can penetrate a wide variety of materials. Terahertz radiation can thus be used for quality control of a variety of materials which are transparent to terahertz radiation, including windshield-flange interface compositions.

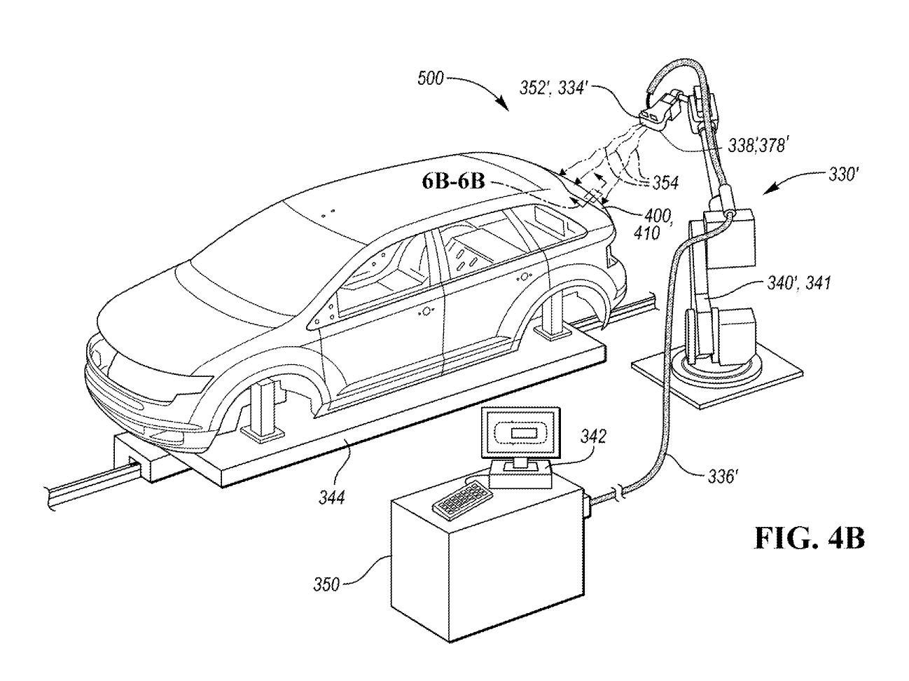

The method utilizes a controller 350 which operates a terahertz pulsed beam generator 352 to direct a terahertz pulsed beam 354 at a windshield-flange interface 300. An example monitoring system including the controller 350, the terahertz pulsed beam generator 352, and a terahertz pulsed beam 354 is depicted in FIGS. 4A and 4B. The reflection and/or refraction of the light from the beam 354 reflected and/or refracted from the different interface layers within the windshield-flange interface is detected by a detector 378. The method may periodically measure the light from the beam 354 reflected or refracted from the interfaces including the adhesive 322. The method may further include outputting a cure rate of the adhesive based on a refractive index associated with the light from the beam 354 reflected or refracted from the interfaces including the adhesive 322.

The typical adhesive used for this application requires chemical reaction with water contained in air to convert the adhesive from semi-liquid or thermoplastic to solid. Once cured, the adhesive generally provides high strength, elasticity, flexibility, resistance to temperature extremes and changes, humidity, and certain chemicals. The moisture-curing adhesive is usually a viscous material which may include pre-polymers. The moisture triggers the curing reaction such that the moisture curing adhesive cures on exposure to moisture either in the substrate or atmosphere. The moisture acts as a reaction catalyst. The relative humidity thus determines the amount of available reaction catalyst. The relative humidity required is typically between about 40% to 70% relative humidity. The cure temperature is typically between 5 to 40° C. Additional moisture can be added to the bond line to facilitate the cure and thus adjust the cure rate. Since moisture from the air starts the cure, curing takes place from the outside to the inside of the adhesive layer at a certain cure rate.

The method may include collecting data on the cure rate of the adhesive in time. The cure rate relates to the rate at which the adhesive develops a sufficient amount of stable links or adhesive bonds between two substrates, the windshield and the flange, to bind the substrates with sufficient strength. The cure rate depends on a number of factors besides the amount of humidity contained in the air, for example on the amount of adhesive applied, the thickness of the adhesive and/or other layers, cure temperature, environmental conditions such as exposure of the substrate(s) to chemicals, vibration, mechanical shocks, or the like.

The collecting of data may include measuring and/or monitoring the progress of the adhesive cure for a certain period of time. The measuring may be done periodically, for example every several minutes, hours, days. The measuring may be done under a variety of conditions simulating production conditions, for example different relative humidity. The measuring may be done on one or more samples for each type of adhesive, for each thickness of the adhesive layer, or both.

The method may include collecting data regarding the adhesive cure rate and the factors influencing the cure rate named above. The collected data may be used to determine a threshold cure rate relating to a desirable cure rate from economical or other prospective. Alternatively, the threshold cure rate may relate to an optimal cure rate under certain environmental conditions or to an optimal cure rate regarding a specific application. The collected data may be used to develop a cure rate model for a specific application of the adhesive to the windshield-flange interface. The model may simulate the polymerization behavior of the adhesive based on any temperature. The polymerization reaction may be described, for example, by a mathematical relation between time, temperature, and the extent of cure. The model may be used to design and optimize the cure process. Other models based on different sets of data are contemplated.

The development of the model may incorporate additional data such as a refractive index value. The refractive index value of a transparent medium refers to the ratio of speed of light in vacuum to the speed of light in the specific medium. The refractive index n is defined as the ratio of the speed of light in vacuum c=2.99×10⁸ m/s and the phase velocity v of light in the medium, n=c/v. The refractive index indicates how much light is bent, or refracted, when entering a layer. The refractive index also determines the amount of light that is reflected or refracted when the radiation reaches an interface between two adjacent layers.

The refractive index value may refer to the ratio of speed of light in vacuum to the speed of light in the windshield, the adhesive, the interface and its individual layers. The refractive index value may relate to the refractive index of the windshield-flange interface at any point during the cure process such as at the beginning of the cure process, after several minutes, hours, and/or days of curing, or the like. A threshold refractive index may relate to the refractive index of an adhesive-layer interface when or after the adhesive first reaches the desired amount of links, indicating desirable strength of the bond between the flange and the windshield. The layer may be the clearcoat layer 320 or the windshield 310. In other words, the threshold refractive index may indicate the desired cure state of the adhesive.

The refractive index of various substrates differs based on their chemistry. As the adhesive cures and more moisture penetrates the adhesive, the chemistry of the adhesive changes, and the refractive index likewise changes. The change of the refractive index is utilized in the process described herein to monitor desirable adhesive cure state.

The method includes providing input to the controller 350. The input may include a number of parameters. The parameters may include any of the collected data, thickness of one or more layers, the threshold cure rate, a refractive index at the beginning of the cure process and/or during any point of the cure process, a threshold refractive index value, the cure rate model of the adhesive, position of the preselected scanning points or line scans to be measured, calibration curves, the measuring interval, the scanning interval, the like, or a combination thereof.

An output provided by the controller 350 may include a cure rate of the adhesive based on a refractive index associated with the light from the beam reflected or refracted from the adhesive. The output may be provided at least once per period. The output may be provided once, twice, 3, 4, 5, 6, 7, 8, 9, 10, 15, 20, 30, or more times per period. The period may include 1 to several hours or days such as 1 to 15 days. The output may be provided periodically in pre-set intervals. Alternatively, the output may be provided randomly.

The measuring of the light from the beam reflected or refracted from the adhesive and providing output based on the measurement may be done on one or more than one vehicles. The output may be provided from a certain amount of interfaces of a plurality of vehicles. The plurality of vehicles may be a group of vehicles whose flange-windshield interface was assembled at the same time, the same type of adhesive was applied to their flange-windshield interfaces, and the vehicles remain under the same environmental conditions during the entire curing process. The plurality of vehicles may include a select number of vehicles. The select number may differ based on the amount of vehicle windshields installed within a relatively short time period such that the adhesive was applied and cures under the same or very similar conditions. Example select number may be about 2, 5, 10, 20, 50, 100, or more. Providing output from one vehicle thus indicates the cure state of the adhesive at the windshield-flange interface for the remaining vehicles in the group. Testing of each vehicle is thus not necessary, but could be conducted.

The output data may be gathered, stored, compared to the developed model, serve to adjust the model, further processed, and/or utilized for monitoring of the adhesive cure progress of one or more vehicles. The output may provide insight as to the influence of the changing environmental conditions on the production speed of the vehicle assembly. The monitoring of the output may be used to adjust the storage of the vehicles-in-production after the windshield is applied onto the flange. The monitoring may help provide sufficient data to effectively remove vehicles from storage or end the windshield-assembly-and-cure process as soon as the desired cure rate is reached while providing assurance that the adhesive bond at the interface is sufficiently strong.

The cure rate provided based on the measuring of the refractive index is an output cure rate. The output cure rate may be expressed as a percentage of a threshold cure rate value which is to be reached and which indicates the desired state of adhesive cure. The output may also include an estimate of time remaining to reach the threshold cure rate based on the output cure rate. The output cure rate may serve additional purposes such as for predicting cure rate. The method may include predicting the cure rate based on the output cure rate(s), the relative humidity level, atmospheric conditions, or other collected data indicated above.

The method may also provide measurement of thickness of individual layers within the windshield-flange interface. For example, to achieve proper cure, a sufficient amount of adhesive has to be added to the interface to cause desirable bond strength. To achieve uniform bond strength throughout the entire interface along the periphery of the windshield, a uniform amount of adhesive resulting in a uniform thickness of the adhesive layer should be applied.

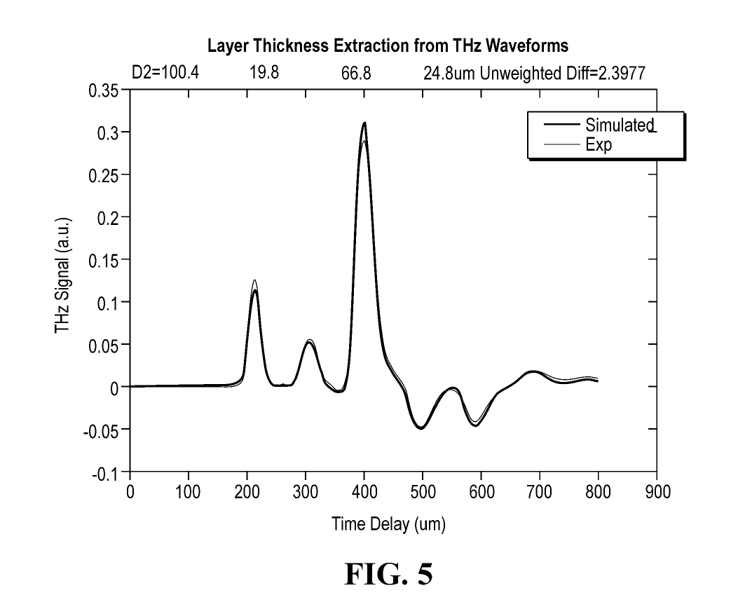

Since the thickness of the paint layers at the windshield-flange interface is relatively thin such as about 25 to 70 μm, the reflection happens in a fast manner and the resulting reflection waveform does not properly indicate individual layer reflections. To effectively extract the adhesive layer thickness measurement, a model may be developed. The model may contain the refractive index of individual layers of the interface. The measured data is then fitted to the model and thickness of individual layers may be thus assessed. The method may thus accurately measure thickness of each layer, including the adhesive layer. The thickness data may be included among the collected data referenced above and/or serve as an input for the method described above. FIG. 5 illustrates an example of a model-generated or simulated waveform and a measured reflected waveform generated by the terahertz radiation beam with regards to an automotive paint system. In the example, the simulated and actual waveforms show a very good correlation.

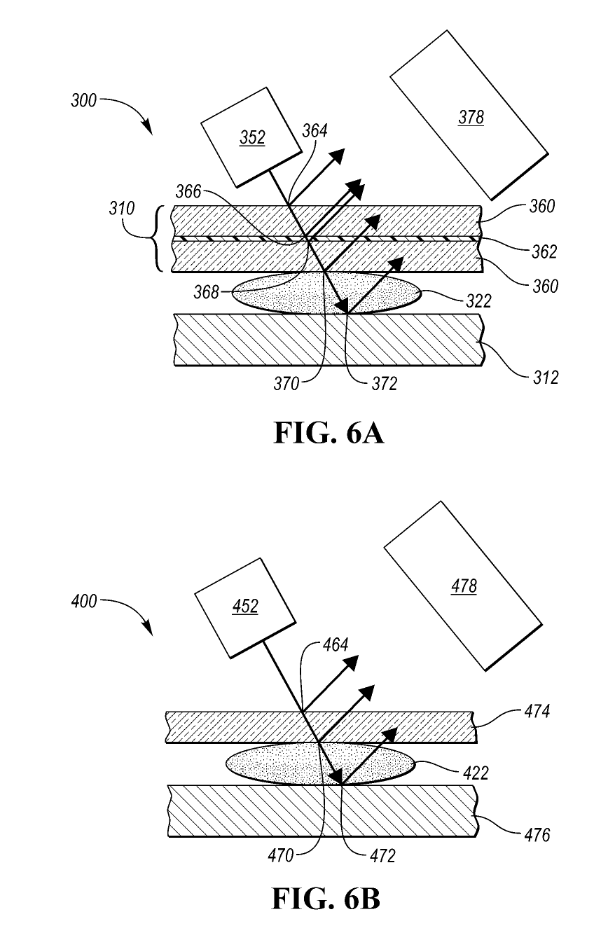

The method may also include adjusting an output cure rate to account for at least one other interface and/or a thickness of the windshield. The windshield itself, depicted in FIG. 3, is a laminated structure including a plurality of layers. The layered structure of the windshield 310 is depicted in FIG. 6A. The windshield 310 includes two glass layers sandwiching a resin layer such as a polyvinyl butyral (PVB) layer 362. The entire windshield is about 5 mm thick, each glass layer 360 having a thickness of about 2.1 mm, and the resin layer 362 being about 0.7 mm thick. The windshield 310 thus has a plurality of interfaces, the top glass-atmosphere interface 364, the top glass layer-resin layer interface 366 and the bottom glass-layer-resin interface 368 in addition to the bottom glass-adhesive interface 370, and adhesive-flange interface 372.

The overall thickness of the laminated windshield 310, and the amount of interfaces may result in a higher than normal signal loss and inaccurate measurements. Hence, to obtain a more accurate measurement, a surrogate for the windshield 310 may be used. The surrogate may be a rear window 474. To serve as a viable surrogate, the rear window 474 should be bonded to the flange 476 under the same conditions under which the laminated windshield 310 was bonded to the flange 312, the type of adhesive and the thickness of the applied adhesive for the windshield-flange and the rear window-flange interfaces should be the same, and the application should be done approximately at the same time. Due to elimination of the interfaces 366 and 368, the amount of individual interfaces the terahertz beam travels through is substantially lower in the interface 400 when compared to the interface 300. The absence of the interfaces 366 and 368 and reduction in the thickness or bulk mass of the glass may result in less signal loss and more accurate results.

The method described above is generally applicable to any glass-metal interface where the two materials, the glass and the metal, are bonded together by an adhesive. The glass may be any non-crystalline amorphous solid material that is transparent. The glass may be chemically-pure silica (SiO₂). Alternatively, the glass may contain less than 100 wt. % of silica and include additional substances such as sodium carbonate, calcium oxide, magnesium oxide, aluminum oxide, lead, germanium oxide, barium, thorium oxide, lanthanum oxide, cerium oxide, the like, or a combination thereof. The glass may be a single layer or a multi-layer laminated glass. The glass may contain one or more resin layers. Alternatively, the glass may be a polymeric substitute of glass, for example polycarbonate. The metal may be any metal including steel, iron, aluminum, copper, titanium, platinum, rhodium, tin, lead, zinc the like, or their alloys. The adhesive may be any type of adhesive capable of bonding glass to metal and/or polymeric material to metal. The adhesive may be a moisture-cure adhesive. The adhesive may be a polyurethane-based, silicone-based adhesive, or the like. The glass-metal interface may include additional layers such as various paint or coating layers mentioned above. The paint or coating layers may further include enamels, putties, under coats, pre-treatment layers, and other layers. The term paint layer, as used herein, includes coatings such as passivation coating and other materials which are applied to a metal surface to improve properties such as appearance, adhesion, wettability, corrosion resistance, wear resistance, scratch resistance, chemical resistance, mechanical resistance, and/or weathering resistance.

The method may employ a terahertz radiation instrument 330. The instrument 330 may include one or more contact and/or non-contact probes (not depicted). The instrument 330 may include a source of terahertz radiation having a terahertz pulsed beam generator or emitter 352 capable of producing terahertz radiation. Any emitter 352 capable of producing terahertz radiation beam 354 may be used. The source of terahertz radiation may be an electronic or photonic source. The electronic source may include an electron-beam source such as fiber lasers, gas lasers, free-electron lasers and synchrotrons, a photoconductive antenna, quantum cascade lasers, sources derived from microwave technology such as Gunn diodes, Impatt diodes, and resonant tunneling diodes, or the like. The photonic source may include a laser-driven terahertz photoconductive antenna, terahertz quantum-cascade lasers, or the like. The emitter 352 may produce radiation pulses or emit terahertz radiation in a continuous wave. The emitter 352 may be coupled to an emitter head 334. The emitter head 334 may include a lens (not depicted) for collecting the terahertz radiation. The emitter head 334 directs the terahertz radiation beam 354 at the windshield-flange or rear window-flange interface.

The instrument 330 may further include a detector 378 capable of detecting radiation beam reflections or refractions or fulfill additional functions. The detector 378 may include one or more sensors 338. The detector 378 may be situated outside of the instrument 330 such that the detector 378 does not form an integral part of the instrument 330. The one or more sensors 338 may be located on the emitter head 334. The instrument 330, the one or more probes, the emitter 352, the emitter head 334, the one or more sensors 338, the detector 378, or a combination thereof may be connected to a microprocessor units (MPU), also known as a central processing unit, or a controller 350. The controller 350 is capable of accepting digital data as input, processing the data according to instructions stored in its memory, and providing output. The controller 350 may be located in a movable member 340, a computer unit 342, or elsewhere as long as the controller can be in communication with the instrument 330, the one or more probes, the emitter 352, the emitter head 334, the one or more sensors 338, the detector 378, or a combination thereof. The communication may be enabled via coupling of the controller 350 with one or more parts of the instrument 330 named above. An example coupling may be provided via a fiber optic cable 336. The controller 350 may include mathematical modeling software which is capable of processing data received from the instrument 330, one or more probes, the emitter head 334, the one or more sensors 338, the detector 378, and/or additional sources of data.

The controller 350 may be programmed to activate the terahertz beam generator 352 to generate the terahertz beam 354, to activate the detector 378 and/or the one or more sensors 338 to receive the reflected or refracted beam, to collect data from the detector 378 and/or one or more sensors 338 about at least a portion of the interface 300, 400, to move the movable member 340, to process input, to generate output indicative of a cure rate of the adhesive based on a refractive index associated with light from the beam reflected or refracted from the adhesive 322, 422 and/or the interface 300, 400, and their individual layers and/or interfaces, to generate output indicative of the adhesive layer 322, 422 thickness.

The controller 350 may be programmed to collect data periodically or continuously. A time period between collection of data from the same point of the interface 300, 400 defines a measuring interval. The measuring interval may be 1, 2, 5, 10, 15, 20, 24, 36, 48 hours or longer. A time period between collection of data from two different points on the interface 300, 400 defines a scanning interval. In one or more embodiments, the scanning interval may be about a hundredth of a second, a tenth of a second, a second, 10 seconds, 100 seconds, or longer. Both the measuring and scanning intervals may be adjusted according to the needs of a specific application.

The controller 350 may be further programmed to calculate the immediate state of adhesive cure, provide information about the state of cure as a percentage of cure, estimate the remaining time required for adhesive cure depending on current and/or future atmospheric conditions, the like, or a combination thereof. To provide the estimate, the controller 350 may be supplied input including various weather-related data such as ambient temperature or relative humidity. The weather-related data may be supplied and updated continuously or periodically, depending on the current state of weather.

The terahertz radiation beam 354 may be directed at the interface 300, 400 from a distance. This allows no-contact non-destructive assessment of the windshield-flange interface 300 and/or the rear window-flange interface 400 and determination of the adhesive cure rate and adhesive cure state without contacting or compromising quality of the interface 300 and/or 400. The distance d between the emitter head 334 and the interface 300, 400 may be adjusted according to the needs of a specific application. The distance d may be about 2.5 cm or less to about 25 cm or more.

In one or more embodiments, the emitter head 334 may be portable. The emitter head 334 may be handheld and/or easily adjustable so that the terahertz radiation beam 354 may be directed at the interface 300, 400 in a desirable angle and from a desirable distance. The emitter head 334 may be affixed to a member which is not movable. Alternatively, the emitter head 334 may be permanently or temporarily affixed to a movable member 340 capable of translating the emitter head 334 above the interface 300, 400.

The movable member 340 may be capable of adjusting the distance d. In at least one embodiment, the movable member 340 may be capable of moving up, down, left, right, forward, backward, towards the painted surface, away from the painted surface, in a plane, at an angle. The movable member 340 may move at different speeds according to the needs of a specific application. The movable member 340 may be capable of translating the emitter head 334 above an entire interface 300, 400 or a portion of the interface 300, 400. The movable member 340 may be capable of translating the emitter head 334 across a width w of the windshield 310, rear window 410 so that a line scan is generated from the measured data. The movable member 340 may be capable of translating the emitter head 334 to collect data from a number of points across the interface 300, 400. The movable member 340 may be also capable of translating the emitter head 334 across the interface 300, 400 so that an area map can be created from the collected data. The movable member's 340 path may be preprogrammed, automated, adjusted by a software. The movable member 340′ may be a robot arm 341, as is depicted in FIG. 4B.

As FIG. 4B illustrates, the robot arm 341 may be located in the vicinity of the vehicle body 500. The robot arm 341 may be able to access each side of the vehicle body 500 and thus reach the rear window-flange interface 400, as shows in FIG. 4B. In addition, or alternatively, the robot arm 341 may be configured to reach the windshield-flange interface 300, depicted in FIG. 4A, as well. The robot arm 341 may include a source of terahertz radiation having a terahertz pulsed beam generator or emitter 352′ capable of producing terahertz radiation. The robot arm 341 may include an emitter head 334′. The robot arm 341 may also include a detector 378′ or specifically one or more sensors 338′ capable of detecting the reflection and/or refraction of the light from the beam 354 reflected and/or refracted from the different interface layers within the interface 300, 400. The robot arm 341 may be connected to a controller 350. A controller 350 may be alternatively placed in the robot arm 341 as well.

Alternatively, or in addition to the emitter head 334 being translated above the interface 300, 400, the vehicle body 500 or a portion of the vehicle body 500 may be located on a platform 344 or any other device capable of changing position and/or location of the vehicle body 500 or a portion of the vehicle body 500, as is depicted in FIG. 4A. In at least one embodiment, the emitter head 334 may thus be stationary and scan the interface 300, 400 while the interface 300, 400 is being moved beneath the emitter head 334.

The method may include a step of scanning the interface 300, 400 with the terahertz radiation instrument 330 to obtain data about the adhesive layer thickness, and/or about the cure rate of the adhesive 322, 422. The scanning step may include scanning of the entire length of the periphery of the interface 300, 400, one or more separate portions of the interface 300, 400, or a single point along the periphery of the interface 300, 400. The scanning step may include emitting terahertz radiation from the instrument 330. The scanning step may include emitting terahertz radiation pulses or continuous waves having amplitude oscillating at a terahertz frequency. The scanning step may include directing the terahertz radiation beam 354 from the emitter head 334 at the interface 300, 400 to be assessed.

The scanning step may include positioning of the emitter head 334 above the interface 300, 400 and/or positioning of the interface 300, 400 beneath the emitter head 334. The positioning may be performed using a laser rangefinder, ultrasonics, machine vision, an absolute position of the robot relative to the surface normal, the like, or a combination thereof. The positioning may include determining a tangent plane via one or more sensors 338 and positioning the emitter head 334 based on the tangent plane. The scanning step may include positioning the emitter head 334 according to a vector that is perpendicular to the tangent plane and/or according to a distance of the emitter head 334 from the tangent plane.

In one or more embodiments, the scanning step may further include translating the emitter head 334 above the interface 300, 400. Alternatively, the scanning step may include scanning with a stationary emitter 332 and translating the interface 300, 400 or a portion of the vehicle body 500 beneath the instrument 330. The method may include a step of programming the controller 350 to generate the instrument's scanning path to enhance the speed at which the emitter head 334 moves over the interface 300, 400.

In at least one embodiment, the scanning step may include scanning a series of preselected points on the interface 300, 400. As FIG. 4A illustrates, example scanned points A-E may be located in different portions along the periphery of the interface. While the example scanned points A-E are depicted on the windshield 310 in FIG. 4A, the scanned points may be located on the rear window instead or in addition to the points on the windshield. The series of points may be chosen in a random fashion, according to an algorithm, or chosen for specific reasons such as a point with lesser access to atmospheric moisture. A high density of points can be scanned, and their position may be well known. Different or the same series of points may be scanned during the monitoring process.

Dimensions of the area to be scanned may differ. The method may include a step of adjusting a spot size of the terahertz radiation beam 354 according to the dimensions of the desired scanned area. A scanned area may include the entire width of the interface 300, 400. Alternatively, a scanned area may be relatively small and encompass only a portion of the width or length of the interface 300, 400.

The thickness of the adhesive layer at the interface 300 is a critical performance characteristic as the thickness is directly related to windshield bonding strength. The scanned area on the windshield flange 312 may be as small as less than about 1 cm², about 1 cm², or more than about 1 cm². The diameter of the scanned area may be less than about 500 μm, 250 μm, 100 μm, or 50 μm. The diameter of the scanned area may be about 25 μm or less to about 2 cm or more. Accordingly, the spot size of the terahertz radiation beam 354 may be adjusted from about 1 cm to about 0.5 μm or from about 10 cm to about 500 μm. Alternatively, the scanning step may include scanning a series of points in a linear fashion across a portion of the interface 300, 400 to produce a line scan.

The method may include one or more steps. The steps may be performed in any order and may be repeated as needed.

The method may include a step of collecting data for the adhesive layer 322. The method may include a step of acquiring data of the adhesive layer 322 as a function of the emitter head's 334 position. The method may further include recording reflections or refractions of the terahertz radiation wave from each interface of the interface 300, 400 by one or more sensors 338. The method may include inputting the collected data into the controller 350 and determining thickness of the adhesive layer 322 utilizing the controller 350. The method may include a step of determining thickness of the adhesive layer 322 based on a refractive index of the adhesive layer 322 and/or time delay of the reflections or refractions from each interface such as the windshield-adhesive interface and the clearcoat-adhesive interface.

The method may utilize mathematical modeling to process the collected data and/or to generate a thickness graph, map, chart, table, the like, or a combination thereof of the adhesive layer 32. The method may include quantifying the thickness data using software. The method may include displaying the thickness data for analysis in the form of one or more graphs, maps, tables, charts, images, plots, or the like.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method of assessing cure rate of an adhesive adhering a windshield to a flange comprising:
by a controller,
operating a terahertz beam generator to direct a terahertz beam at a windshield-flange interface;
periodically measuring light from the beam reflected from the adhesive; and
outputting a cure rate of the adhesive based on a refractive index associated with the light from the beam reflected from the adhesive.

2. The method of claim 1, further comprising comparing the cure rate to a threshold cure rate or a cure rate model of the adhesive.

3. The method of claim 1, wherein the measuring occurs at least once a day.

4. The method of claim 1, further comprising adjusting an output cure rate to account for at least one other interface and a thickness of the windshield.

5. The method of claim 1, further comprising outputting a predicted cure rate based on the cure rate and a relative humidity level or other atmospheric conditions.

6. The method of claim 1, wherein the cure rate is expressed as a percentage of a threshold cure rate.

7. The method of claim 1 further comprising outputting an estimate of time remaining to reach a threshold cure rate based on the cure rate.

8. An apparatus comprising:
a terahertz beam generator directed at a windshield-flange interface including an adhesive; and
a controller programmed to activate the terahertz beam generator to generate a terahertz beam, and generate output indicative of a cure rate of the adhesive based on a refractive index associated with light from the beam reflected from the adhesive.

9. The apparatus of claim 8, wherein the output is generated while the beam scans at least a portion of the interface.

10. The apparatus of claim 8, wherein the output is an estimate of time remaining to reach a threshold cure rate of the adhesive.

11. The apparatus of claim 8, wherein the output is a percentage of a threshold cure rate of the adhesive.

12. The apparatus of claim 8, wherein the controller is further programmed to compare the output to an input, the input being a threshold refractive index value, a threshold cure rate, a threshold speed of a refraction, or a cure rate model of the adhesive.

13. The apparatus of claim 8, wherein the controller is programmed to activate the beam generator periodically.

14. An apparatus comprising:
a controller programmed to activate a beam generator to generate a terahertz beam directed at an adhesive of a glass-metal flange interface, and generate output indicating status of a cure rate of the adhesive based on a refractive index associated with velocity of light of the beam reflected from the adhesive and a threshold adhesive cure rate.

15. The apparatus of claim 14, wherein the glass-metal flange interface comprises a windshield-flange interface.

16. The apparatus of claim 14, wherein the glass-metal flange interface comprises a rear vehicular glass-flange interface.

17. The apparatus of claim 14, wherein the output is generated periodically.

18. The apparatus of claim 14, wherein the controller is further programmed to estimate time remaining to reach the threshold adhesive cure rate based on the output.

19. The apparatus of claim 14, wherein the status is a percentage of the threshold adhesive cure rate.

20. The apparatus of claim 14, wherein the controller is further programmed to generate output indicating status of a cure rate of the adhesive based on a refractive index associated with velocity of light of the beam refracted from the adhesive and a threshold adhesive cure rate.
